(19) United States
(12) Patent Application Publication
(10) Pub. No.: US 2020/0200710 A1
(43) Pub. Date: Jun. 25, 2020

(54) PARTICLE DETECTION ELEMENT AND PARTICLE DETECTOR

(71) Applicant: NGK INSULATORS, LTD., Nagoya-City (JP)

(72) Inventors: Keiichi Kanno, Nagoya-City (JP); Kazuyuki Mizuno, Nagoya-City (JP); Hidemasa Okumura, Nagoya-City (JP)

(73) Assignee: NGK INSULATORS, LTD., Nagoya-City (JP)

(21) Appl. No.: 16/806,127

(22) Filed: Mar. 2, 2020

Related U.S. Application Data
(63) Continuation of application No. PCT/JP2018/029056, filed on Aug. 2, 2018.

(30) Foreign Application Priority Data
Sep. 6, 2017 (JP) 2017-171121

(51) Int. Cl. G01N 27/70

(52) U.S. Cl. CPC G01N 27/70

(57) ABSTRACT

A particle detection element includes: a casing having a gas flow passage; an electric charge generating unit that imparts charges generated by a discharge to particles in a gas introduced into the casing to thereby form charged particles; a collecting electrode that is disposed inside the casing so as to be exposed to the gas flow passage and collects a collection target that is the charged particles or the charges not imparted to the particles; and a plurality of exposed electrodes including the collecting electrode and exposed to the gas flow passage. The casing has a short circuit-preventing structure disposed on a connection surface that is part of an inner circumferential surface exposed to the gas flow passage. The connection surface connects at least two of the plurality of exposed electrodes to each other, and the short circuit-preventing structure includes at least one of a recess and a protrusion.

### BACKGROUND OF THE INVENTION

### 1. Field of the Invention

The present invention relates to a particle detection element and to a particle detector.

### 2. Description of the Related Art

In one known conventional particle detector, electric charges are imparted to particles in a measurement gas introduced into a casing to collect the charged particles by a measurement electrode, and the number of particles is measured based on the amount of charges on the collected particles (e.g., PTL 1).

### CITATION LIST

### Patent Literature

PTL 1: International Publication No. WO 2015/146456

### SUMMARY OF THE INVENTION

In a particle detector, electrically conductive particles may adhere to the inner circumferential surface of the casing. In this case, the adhered particles may form a short circuit path between electrodes exposed at the inner circumferential surface of the casing to cause the electrodes to be short-circuited.

The present invention has been made to solve the foregoing problem, and a principal object of the invention is to prevent a short circuit between the exposed electrodes.

To achieve the above principal object, the present invention adopts the following measures.

The particle detection element of the present invention is a particle detection element used to detect particles in a gas, the particle detection element including:

a casing having a gas flow passage through which the gas passes;
an electric charge generating unit that imparts charges generated by a discharge to the particles in the gas introduced into the casing to thereby form charged particles;
a collecting electrode that is disposed inside the casing so as to be exposed to the gas flow passage and collects a collection target that is the charged particles or the charges not imparted to the particles; and
a plurality of exposed electrodes that include the collecting electrode and are exposed to the gas flow passage,
wherein the casing has a short circuit-preventing structure disposed on a connection surface that is part of an inner circumferential surface exposed to the gas flow passage, the connection surface connecting at least two of the plurality of exposed electrodes to each other, the short circuit-preventing structure including at least one of a recess and a protrusion.

In this particle detection element, the electric charge generating unit generates electric charges to thereby convert particles in the gas into charged particles, and the collecting electrode collects the collection target (the charged particles or the charges not imparted to the particles). Since a physical quantity varies according to the collection target collected by the collecting electrode, the use of the particle detection element allows the particles in the gas to be detected. In this case, during the use of the particle detection element, part of the particles may gradually adhere to the inner circumferential surface of the casing. Therefore, when at least part of the particles have electrical conductivity, the conductive particles may adhere to the inner circumferential surface of the casing to form a short circuit path between exposed electrodes. However, the casing of the particle detection element of the present invention has the short circuit-preventing structure having at least one of the recess and the protrusion and disposed on the connection surface that is part of the inner circumferential surface exposed to the gas flow passage and connects at least two exposed electrodes to each other. Since the short circuit-preventing structure increases the path length between the exposed electrodes along the connection surface, a short circuit path is unlikely to be formed between the exposed electrodes even when the particles adhere to the inner circumferential surface. Therefore, in this particle detection element, the occurrence of a short circuit between at least two exposed electrodes can be prevent. In this case, the particle detection element of the present invention may be used to detect the amount of the particles in the gas. The “amount of the particles” may be, for example, at least one of the number, mass, and surface area of the particles.

In the particle detection element of the present invention, the exposed electrodes may include an electric field generating electrode that is disposed inside the casing and generates an electric field that causes the collection target to move toward the collecting electrode, and the casing may have a partition that partitions the gas flow passage into a plurality of branched flow passages. The collecting electrode and the electric field generating electrode may be each exposed to one of the plurality of branched flow passages, and the casing may have the short circuit-preventing structure on the connection surface that is a portion connecting the collecting electrode and the electric field generating electrode to each other. When the collecting electrode and the electric field generating electrode are disposed so as to face one of the branched flow passages, the path length between the electrodes along the connection surface tends to be short. Therefore, it is highly significant to dispose the short circuit-preventing structure on the connection surface between the collecting electrode and the electric field generating electrode.

In this case, the collecting electrode and the electric field generating electrode may form a pair of electrodes. The particle detection element may include a plurality of the pairs of electrodes disposed such that each of the plurality of pairs of electrodes is disposed in a corresponding one of the plurality of branched flow passages, and the connection surface for at least one of the plurality of pairs of electrodes disposed in the respective branched flow passages may have the short circuit-preventing structure. In this case, the plurality of pairs of electrodes are disposed in the respective branched flow passages. For the pair of electrodes between which the connection surface having the short circuit-preventing structure is interposed, a short circuit between the collecting electrode and the electric field generating electrode can be prevented.

In the particle detection element of the present invention, the casing may be a layered body including a plurality of layers stacked on top of each other, and the at least one of the recess and the protrusion may be connected to a surrounding portion thereof on the connection surface at a step portion that is a step between two adjacent layers of the plurality of layers. In this case, by simply stacking the adjacent layers such that the step portion is formed therebetween, the recess or the protrusion can be formed. Therefore, the layered body having the recess or the protrusion can be produced relatively easier than, for example, a layered body produced by forming a layer and then subjecting the formed layer to processing for forming the recess or the protrusion.

The particle detection element of the present invention may include a heating unit that heats the connection surface of the casing. In this case, particles adhering to the connection surface can be burnt and removed using the heating unit, and the formation of a short circuit path on the connection surface can be prevented. Since the connection surface has the short circuit-preventing structure, a short circuit between the exposed electrodes can be prevented. Therefore, for example, the time interval during which the heater is not used can be increased.

In the particle detection element of the present invention, the exposed electrodes may include an electric field generating electrode that is disposed inside the casing and generates an electric field that causes the collection target to move toward the collecting electrode. In a cross section perpendicular to a center axis of the gas flow passage, the inner circumferential surface of the casing may have a polygonal shape. The inner circumferential surface may include; a collecting electrode-disposed surface which is a surface forming a side of the polygonal shape and on which the collecting electrode is disposed; and an electric field generating electrode-disposed surface which is a surface forming a side of the polygonal shape and on which the electric field generating electrode is disposed. The short circuit-preventing structure may be disposed on a connection side surface that is part of the connection surface, which part connects the collecting electrode-disposed surface to the electric field generating electrode-disposed surface. In this case, the cross section of the inner circumferential surface of the casing may have a rectangular shape. The “polygonal shape” is meant to include a substantially polygonal shape, and the cross section of the inner circumferential surface may have, for example, a shape that is not strictly polygonal because the connection surface has the short circuit-preventing structure. Similarly, the “rectangular shape” is meant to include a substantially rectangular shape.

The particle detection element of the present invention may include an electric field generating electrode that is disposed inside the casing and generates a collecting electric field that causes the collection target to move toward the collecting electrode. In this case, the exposed electrodes include the electric field generating electrode (i.e., the electric field generating electrode is exposed to the gas flow passage), and the casing may have the short circuit-preventing structure on a connection surface that is a portion connecting the collecting electrode to electric field generating electrode.

In the particle detection element of the present invention, the electric charge generating unit may include: a discharge electrode disposed so as to be exposed to the gas flow passage within the casing; and a counter electrode that is disposed so as to be exposed to the gas flow passage within the casing and faces the discharge electrode. Specifically, the exposed electrodes may include the discharge electrode and the counter electrode. In this case, the casing may have the short circuit-preventing structure on a connection surface that is a portion connecting the discharge electrode to the counter electrode.

In the particle detection element of the present invention, the collection target may be the charged particles, and the particle detection element may include: a removing electrode that is disposed on the upstream side of the collecting electrode with respect to the flow of the gas and collects the charges not imparted to the particles; and an application electrode that generates a removing electric field that causes the charges not imparted to the particles to move toward the removing electrode. In this case, the exposed electrodes include the removing electrode and the application electrode (i.e., the removing electrode and the application electrode are exposed to the gas flow passage), and the casing may have the short circuit-preventing structure on a connection surface that is a portion connecting the removing electrode to the application electrode.

The particle detector of the present invention includes: the particle detection element according to any one of the above modes; and a detection unit that detects the particles based on a physical quantity that varies according to the collection target collected by the collecting electrode. Therefore, this particle detector has the same effects as those of the particle detection element of the present invention described above. For example, one of the effects is that a short circuit between at least two exposed electrodes can be prevented. In this case, the detection unit may detect the amount of the particles based on the physical quantity. The “amount of the particles” may be, for example, at least one of the number, mass, and surface area of the particles. In this particle detector, when the collection target is charges not imparted to the particles, the detection unit may detect the particles based on the physical quantity and the charges (e.g., the number of charges or the amount of charges) generated by the electric charge generating unit.

In the present description, the “charges” are meant to include positive charges, negative charges, and ions. The phrase “to detect the amount of particles” is meant to include the case where the amount of particles is measured and the case where whether or not the amount of particles falls within a prescribed numerical range is judged (whether or not the amount of particles exceeds a prescribed threshold value is judged). The “physical quantity” may be any parameter that varies according to the number of collection target objects (the amount of charges) and is, for example, an electric current.

### BRIEF DESCRIPTION OF THE DRAWINGS

FIG. 1 is a perspective view showing a schematic structure of a particle detector 10.

FIG. 2 is an A-A cross-sectional view of FIG. 1.

FIG. 3 is a partial cross-sectional view of a B-B cross section of FIG. 1.

FIG. 4 is a partial cross-sectional view showing the surroundings of a left connection surface 70a in FIG. 3.

FIG. 5 is an exploded perspective view of a particle detection element 11.

FIG. 6 is a partial cross-sectional view showing a short circuit-preventing structure 175a in a modification.

FIG. 7 is a partial cross-sectional view showing a short circuit-preventing structure 275a in a modification.

FIG. 8 is a partial cross-sectional view showing a short circuit-preventing structure 375a in a modification.

FIG. 9 is a cross-sectional view of a particle detector 710 in a modification.

FIG. 10 is a C-C cross-sectional view of FIG. 9.

### DETAILED DESCRIPTION OF THE INVENTION

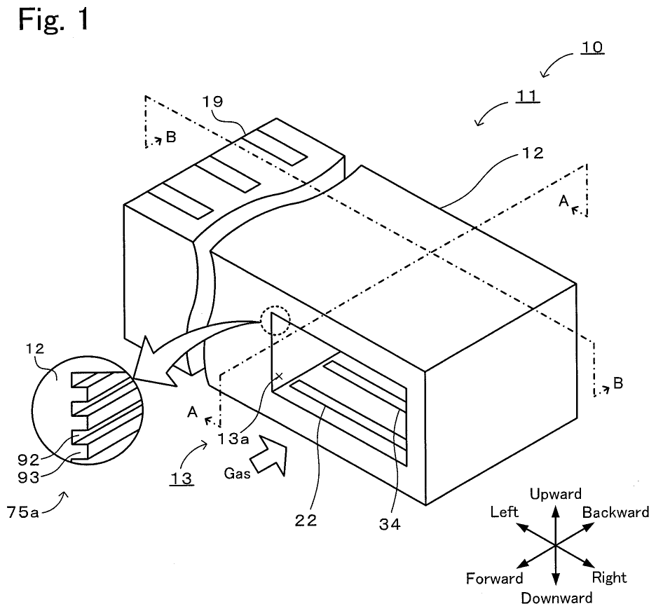

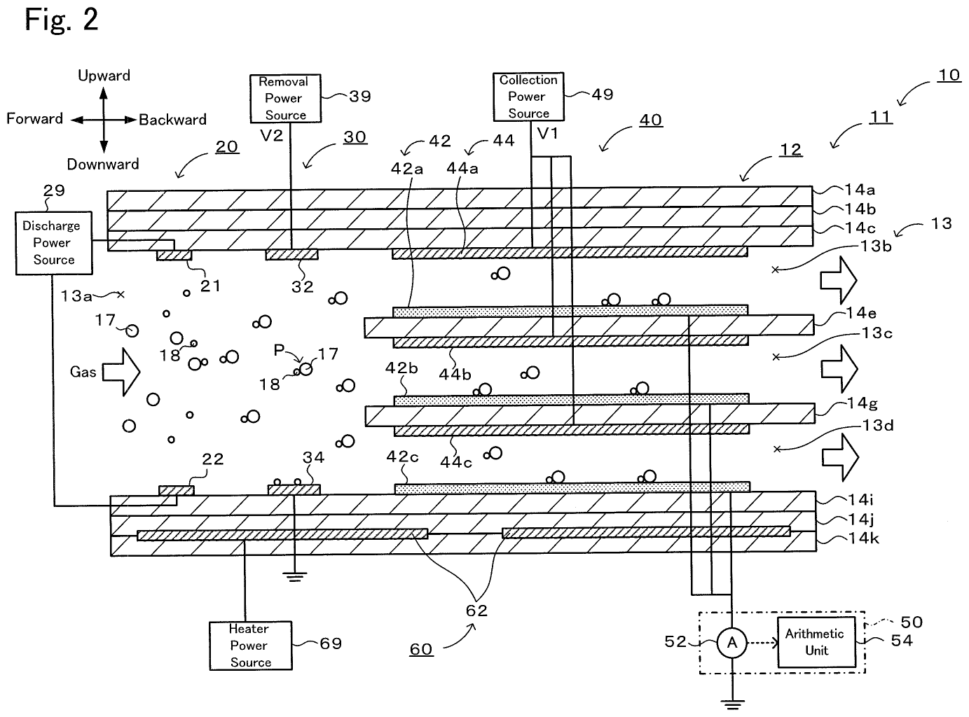

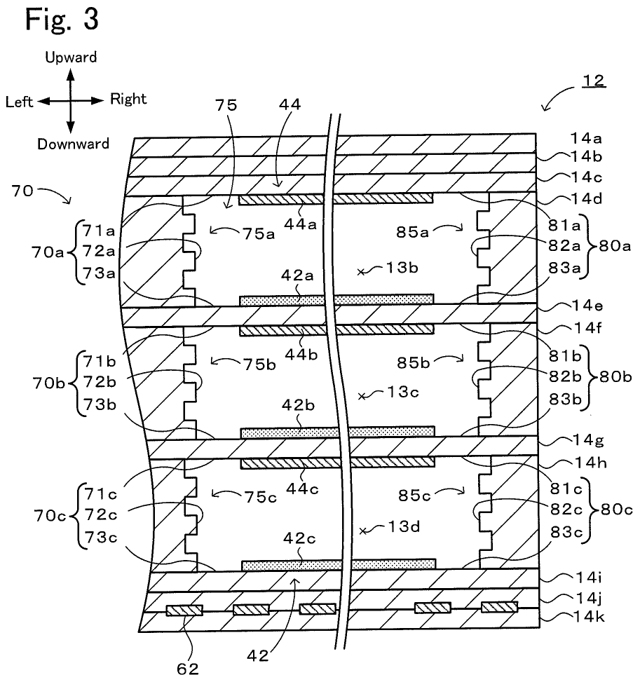

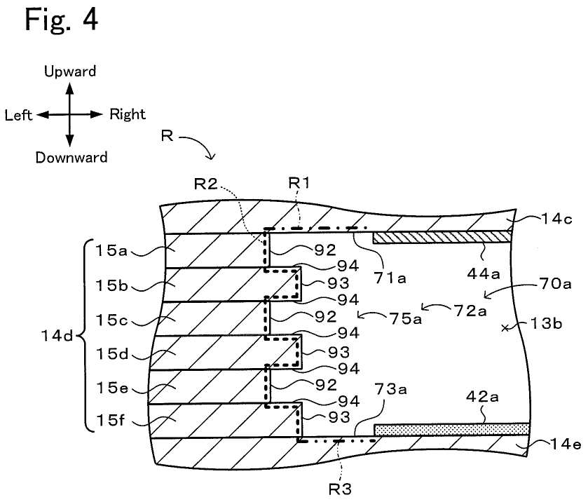

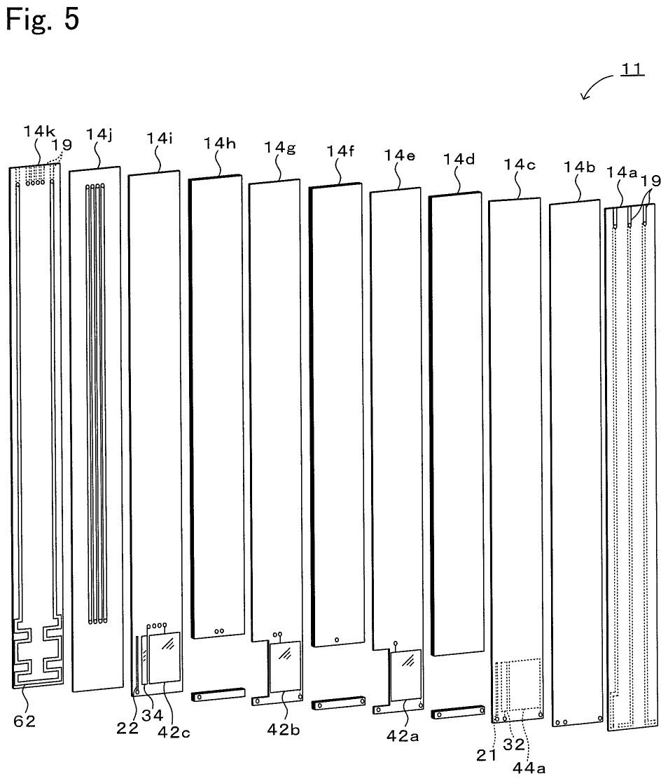

Next, an embodiment of the present invention will be described with reference to the drawings. FIG. 1 is a perspective view showing a schematic structure of a particle detector 10 that is an embodiment of the particle detector of the present invention. FIG. 2 is an A-A cross-sectional view of FIG. 1, and FIG. 3 is a partial cross-sectional view of a B-B cross section of FIG. 1. FIG. 4 is a partial cross-sectional view showing the surroundings of a left connection surface 70a in FIG. 3, and FIG. 5 is an exploded perspective view of a particle detection element 11. In the present embodiment, upward and downward directions, left and right directions, and forward and backward directions are as shown in FIGS. 1 to 4.

The particle detector 10 counts the number of particles 17 contained in a gas (for example, exhaust gas from an automobile). As shown in FIGS. 1 and 2, the particle detector 10 includes the particle detection element 11. As shown in FIG. 2, the particle detector 10 includes a discharge power source 29, a removal power source 39, collection power source 49, a detector 50, and a heater power source 69. As shown in FIG. 2, the particle detection element 11 includes a casing 12, an electric charge generator 20, an excess electric charge removing unit 30, a collector 40, and a heater 60.

The casing 12 has therein a gas flow passage 13 through which gas passes. As shown in FIG. 2, the gas flow passage 13 includes: a gas inlet 13a for introducing the gas into the casing 12; and a plurality of (three in this case) branched flow passages 13b to 13d which are located downstream of the gas introduction port 13a and through which branched gas flows pass. The gas introduced into the casing 12 from the gas inlet 13a is discharged from the casing 12 through the branched flow passages 13b to 13d. A cross section of the gas flow passage 13 that is perpendicular to the center axis of the gas flow passage 13 (a cross section in the vertical and left-right directions) has a substantially rectangular shape. Cross sections of the gas inlet 13a and the branched flow passages 13b to 13d that are perpendicular to the center axis of the gas flow passage 13 have a substantially rectangular shape. As shown in FIGS. 1 to 5, the casing 12 has an elongated substantially cuboidal shape. As shown in FIGS. 2, 3, and 5, the casing 12 is formed as a layered body in which a plurality of layers (first to eleventh layers 14a to 14k in this case) are stacked in a prescribed stacking direction (a vertical direction in this case). The casing 12 is an insulator and is made of a ceramic such as alumina. Through holes or notches are provided in the fourth to eighth layers 14d to 14h so as to pass therethrough in their thickness direction (in the vertical direction in this case), and the through holes or the notches serve as the gas flow passage 13. The first to third layers 14a to 14c form the ceiling of the gas flow passage 13. The fifth layer 14e is formed as a partition that vertically separates the branched flow passage 13b and the branched flow passage 13c from each other. The seventh layer 14g is formed as a partition that vertically separates the branched flow passage 13c and the branched flow passages 13d from each other. The ninth to eleventh layers 14i to 14k form the bottom of the gas flow passage 13. As shown in FIG. 3, the fourth, sixth, and eighth layers 14d, 14f, and 14h form the side walls (the left and right walls in this case) of the branched flow passages 13b, 13c, and 13d, respectively. In the present embodiment, the fourth, sixth, and eighth layers 14d, 14f, and 14h are thicker than other layers. As shown in FIG. 4, the fourth, sixth, and eighth layers 14d, 14f, and 14h each include a plurality of layers (six layers 15a to 15f in this case). Therefore, the casing 12 in the present embodiment is a layered body including 26 stacked layers. In the fourth, sixth, and eighth layers 14d, 14f, and 14h, left side surfaces 72a to 72c and right side surfaces 82a to 82c that face the branched flow passages 13b to 13d each have a short circuit-preventing structure 75 including recesses 92 and protrusions 93 (see FIG. 4). The short circuit-preventing structures 75 will be described later.

As shown in FIG. 2, the electric charge generator 20 includes a discharge electrode 21 and a counter electrode 22 that are disposed within the casing 12 on the side close to the gas inlet 13a. The discharge electrode 21 is disposed on the lower surface of the third layer 14c and exposed to the gas flow passage 13. The counter electrode 22 is disposed on the upper surface of the ninth layer 14i and exposed to the gas flow passage 13. The discharge electrode 21 and the counter electrode 22 are disposed along the inner circumferential surface of the gas flow passage 13 within the casing 12. The counter electrode 22 is disposed so as to face the discharge electrode 21 with the gas flow passage 13 interposed therebetween. The discharge electrode 21 and the counter electrode 22 are each a rectangular flat plate-shaped electrode. The discharge electrode 21 and the counter electrode 22 are connected to the discharge power source 29. The counter electrode 22 may be connected to the ground.

In the electric charge generator 20, when a high voltage (e.g., a DC voltage or a high-frequency pulse voltage) is applied between the discharge electrode 21 and the counter electrode 22 from the discharge power source 29, a discharge occurs in the vicinity of the discharge electrode 21 due to the potential difference between the electrodes. Gas present around the discharge electrode is thereby ionized by the discharge, and charges 18 (positive charges in this case) are generated. The charges 18 are imparted to the particles 17 in the gas passing through the electric charge generator 20, and charged particles P are thereby formed (see FIG. 2).

The excess electric charge removing unit 30 includes an application electrode 32 and a removing electrode 34. The application electrode 32 and the removing electrode 34 are located downstream of the electric charge generator 20 but upstream of the collector 40. The application electrode 32 is disposed on the lower surface of the third layer 14c and exposed to the gas flow passage 13. The removing electrode 34 is disposed on the upper surface of the ninth layer 14i and exposed to the gas flow passage 13. The application electrode 32 and the removing electrode 34 are disposed in positions facing each other. The application electrode 32 is an electrode to which a small positive potential V2 is applied from the removal power source 39. The removing electrode 34 is an electrode connected to the ground. In this case, a weak electric field is generated between the application electrode 32 and the removing electrode 34 of the excess electric charge removing unit 30. Therefore, among the charges 18 generated by the electric charge generator 20, excess charges 18 not imparted to the particles 17 are attracted to the removing electrode 34 by this weak electric field, captured by the removing electrode 34, and discarded to the ground. In this manner, the excess electric charge removing unit 30 prevents the excess charges 18 from being collected by collecting electrodes 42 of the collector 40 and counted as the particles 17.

The collector 40 is a device for collecting a collection target (the charged particles P in this case) and is disposed in the branched flow passages 13b to 13d located downstream of the electric charge generator 20 and the excess electric charge removing unit 30. The collector 40 includes one or more collecting electrodes 42 for collecting the charged particles P and one or more electric field generating electrodes 44 for causing the charged particles P to move toward the collecting electrodes 42. In the present embodiment, the collector 40 includes first to third collecting electrodes 42a to 42c as the collecting electrodes 42 and first to third electric field generating electrodes 44a to 44c as the electric field generating electrodes 44. The collecting electrodes 42 and the electric field generating electrodes 44 are disposed so as to be exposed to the gas flow passage 13. The first collecting electrode 42a and the first electric field generating electrode 44a form a pair of electrodes. Similarly, the second collecting electrode 42b and the second electric field generating electrode 44b form a pair of electrodes, and the third collecting electrode 42c and the third electric field generating electrode 44c form a pair of electrodes. Specifically, the collector 40 includes a plurality of pairs (three pairs in this case) of electrodes. Each pair of electrodes (one collecting electrode 42 and one electric field generating electrode 44 forming a pair) are disposed at positions facing each other vertically. Each of the first to third electric field generating electrodes 44a to 44c generates an electric field that causes the charged particles P to move toward a corresponding one of the first to third collecting electrodes 42a to 42c. One pair of electrodes is disposed in each of the branched flow passage 13b to 13c. Specifically, the first electric field generating electrode 44a is disposed on the lower surface of the third layer 14c, and the first collecting electrode 42a is disposed on the upper surface of the fifth layer 14e. The second electric field generating electrode 44b is disposed on the lower surface of the fifth layer 14e, and the second collecting electrode 42b is disposed on the upper surface of the seventh layer 14g. The third electric field generating electrode 44c is disposed on the lower surface of the seventh layer 14g, and the third collecting electrode 42c is disposed on the upper surface of the ninth layer 14i.

A voltage V1 is applied from the collection power source 49 to the first to third electric field generating electrodes 44a to 44c. The first to third collecting electrodes 42a to 42c are each connected to the ground through an ammeter 52. In this case, an electric field directed from the first electric field generating electrode 44a toward the first collecting electrode 42a is generated in the branched flow passage 13b, and an electric field directed from the second electric field generating electrode 42b toward the second collecting electrode 42b is generated in the branched flow passage 13c. Moreover, an electric field directed from the third electric field generating electrode 44c toward the third collecting electrode 42c is generated in the branched flow passage 13d. Therefore, the charged particles P flowing through the gas flow passage 13 enter any of the branched flow passages 13b to 13d, are moved downward by the electric field generated therein, attracted to any of the first to third collecting electrodes 42a to 42c, and collected thereby. The voltage V1 is a positive potential, and the level of the voltage V1 is of the order of, for example, 100 V to several kV. The sizes of the electrodes 34 and 42 and the strengths of the electric fields (i.e., the magnitudes of the voltages V1 and V2) on the electrodes 34 and 42 are set such that the charged particles P are collected by the collecting electrodes 42 without being collected by the removing electrode 34 and that the charges 17 not adhering to the particles 18 are collected by the removing electrode 34.

The detector 50 includes the ammeter 52 and an arithmetic unit 54. One terminal of the ammeter 52 is connected to the collecting electrodes 42, and the other terminal is connected to the ground. The ammeter 52 measures a current based on the charges 18 on the charged particles P collected by the collecting electrodes 42. The arithmetic unit 54 computes the number of particles 17 based on the current measured by the ammeter 52. The arithmetic unit 54 may function as a control unit that controls the units 20, 30, 40, and 60 by controlling on/off of each of the power sources 29, 39, 49, and 69 and their voltages.

The heater 60 includes a heater electrode 62 disposed between the tenth layer 14i and the eleventh layer 14k. The heater electrode 62 is, for example, a band-shaped heating element routed in a zigzag pattern. The heater electrode 62 is disposed so as to be present at least directly below the third collecting electrode 42c. As shown in FIG. 3, the heater electrode 62 is disposed so as to be present at least directly below side walls of the branched flow passages 13b to 13d (i.e., the fourth, sixth, and eighth layers 14d, 14f, and 14h) in a cross section perpendicular to the central axis of the gas flow passage 13. In the present embodiment, the heater electrode 62 is routed over almost the entire region directly below the gas flow passage 13 and is present also below the counter electrode 22 and the removing electrode 34. The heater electrode 62 is connected to a heater power source 69 and generates heat when energized through the heater electrode 69. The heat generated by the heater electrode 62 transfers to the electrodes such as the collecting electrodes 42 and the casing 12 by heat conduction through the casing 12, radiation through the gas flow passage 13, etc. to thereby heat these electrodes and the inner circumferential surface of the casing 12.

The short circuit-preventing structures 75 and connection surfaces 70 having the respective short circuit-preventing structures 75 will be described in detail. The casing 12 includes the collecting electrodes 42 and the electric field generating electrodes 44 that are disposed on the inner circumferential surface of the casing 12 that is exposed to the gas flow passage 13. Therefore, portions of the inner circumferential surface of the casing 12 serve as the connection surfaces 70 that connect the collecting electrodes 42 to the respective electric field generating electrodes 44. As shown in FIG. 3, the connection surfaces 70 include left connection surfaces 70a to 70c and right connection surfaces 80a to 80c that correspond to the three pairs of electrodes (the first to third collecting electrodes 42a to 42c and the first to third electric field generating electrodes 44a to 44c). The connection surfaces 70 may serve as short circuit paths between the collecting electrodes 42 and the electric field generating electrodes 44 when conductive particles 17 adhere to the connection surfaces 70. The left connection surfaces 70a to 70c and the right connection surfaces 80a to 80c have short circuit-preventing structures 75a to 75c and 85a to 85c, respectively. The short circuit-preventing structures 75a to 75c and 85a to 85c are referred to collectively as the short circuit-preventing structures 75.

The left connection surface 70a is part of the inner circumferential surface of the casing 12 and connects the first collecting electrode 42a to the first electric field generating electrode 44a on the left side. The left connection surface 70a includes a left ceiling surface 71a, a left side surface 72a connected to the left ceiling surface 71a, and a left bottom surface 73a connected to the left side surface 72a. The left ceiling surface 71a is part of the ceiling surface of the branched flow passage 13b, i.e., the lower surface of the third layer 14c, and is a portion extending from the left edge of the first electric field generating electrode 44a to the fourth layer 14d that is the left side wall of the branched flow passage 13b. The left side surface 72a is the left side surface of the branched flow passage 13b and is an exposed portion of the left side wall (the fourth layer 14d in this case) of the branched flow passage 13b that is exposed to the branched flow passage 13b. The left bottom surface 73a is part of the bottom surface of the branched flow passage 13b, i.e., the upper surface of the fifth layer 14e, and is a portion extending from the fourth layer 14d that is the left side wall of the first branched flow passage 13b to the left edge of the first collecting electrode 42a.

The right connection surface 80a is part of the inner circumferential surface of the casing 12 and connects the first collecting electrode 42a to the first electric field generating electrode 44a on the right side. The right connection surface 80a includes a right ceiling surface 81a, a right side surface 82a, and a right bottom surface 83a. These components are left-right symmetrical to the left ceiling surface 71a, the left side surface 72a, and the left bottom surface 73a, and their detailed description will be omitted.

The left connection surface 70b and the right connection surface 80b are part of the inner circumferential surface of the casing 12 and connect the second collecting electrode 42b to the second electric field generating electrode 44b. The left connection surface 70c and the right connection surface 80c are part of the inner circumferential surface of the casing 12 and connect the third collecting electrode 42c to the third electric field generating electrode 44c. The left connection surfaces 70b and 70c and the right connection surfaces 80b and 80c have the same structures as the left connection surface 70a and the right connection surface 80a, respectively. Therefore, the components of the left connection surfaces 70b and 70c and the right connection surfaces 80b and 80c are denoted by symbols obtained by changing the last character “a” of the corresponding components of the left connection surface 70a and the right connection surface 80a to symbol “b” or symbol “c,” and their detailed description will be omitted.

The left connection surfaces 70a to 70c and the right connection surfaces 80a to 80c have the short circuit-preventing structures 75a to 75c and 85a to 85c, respectively, as the short circuit-preventing structures 75. Since the short circuit-preventing structures 75a to 75c and 85a to 85c have the same structure, only the short circuit-preventing structure 75a will be described in detail. The short circuit-preventing structure 75a is part of the left connection surface 70a. In the present embodiment, the left side surface 72a, which is a portion of the left connection surface 70a that connects the left ceiling surface 71a to the left bottom surface 73a, has the short circuit-preventing structure 75a. As shown in FIG. 4, the short circuit-preventing structure 75a has a plurality of (three in this case) recesses 92 and a plurality of (three in this case) protrusions 93. The plurality of recesses 92 and the plurality of protrusions 93 are arranged alternately in the vertical direction. The recesses 92 are portions of the left side surface 72a that have a shape recessed in a direction away from the central axis of the gas flow passage 13 (the branched flow passage 13b in this case) (recessed toward the left in this case). The protrusions 93 are portions of the left side surface 72a that have a shape protruding in a direction toward the central axis of the gas flow passage 13 (the branched flow passage 13b in this case) (protruding toward the right in this case). A step portion 94 is present between a recess 92 and a protrusion 93 adjacent to each other so as to connect them. In the present embodiment, the short circuit-preventing structure 75a has five step portions 94. As described above, the fourth layer 14d having the left side surface 72a is formed as a layered body including the layers 15a to 15f. Each of the plurality of step portions 94 is formed as a step between adjacent two of the layers 15a to 15f. For example, the uppermost step portion 94 in FIG. 4 is the step between the layer 15a and the layer 15b and is formed as part of the upper surface of the layer 15b. End faces (right end faces in this case) of the layers 15a to 15f that are exposed to the branched flow passage 13b are the end faces of the recesses 92 and the protrusions 93. For example, the entire right end face of the layer 15a is the end face of one of the recesses 92, and the entire right end face of the layer 15b is the end face of one of the protrusions 93. As described above, the recesses 92 and the protrusions 93 correspond one-to-one with the layers 15a to 15f. Preferably, the recesses 92 each form a gap into which particles 17 can come. For example, the width of the recesses 92 may be larger than the average particle diameter of the particles 17. The recesses 92 and the protrusions 93 have widths or shapes that can be distinguished from a fine surface profile that is inevitably formed by the shape of particles forming the layer in which the recesses 92 and the protrusions 93 are disposed (the fourth layer 14d in this case). For example, the widths of the recesses 92 and the protrusions 93 may be 1.5 μm or more. The widths of the recesses 92 and the protrusions 93 may be 300 μm or less. The width direction of the recesses 92 and the protrusions 93 is a direction perpendicular to the center axis of the gas flow passage 13 (the vertical direction in this case). The protrusion height of the protrusions 93 (equal to the length of the step portions 94 in the left-right direction) may be 20 μm or more. The protrusion height of the protrusions 93 may be 100 μm or less.

When the short circuit-preventing structure 75a is present, the left connection surface 70a has an increased path length R along the left connection surface 70a between the first collecting electrode 42a and the first electric field generating electrode 44a. For example, the path length R along the left connection surface 70a in FIG. 4 is the sum of a path length R1 that is the length of the left ceiling surface 71a in the left-right direction, a path length R2 that is a length along the recesses 92, the protrusions 93, and the step portions 94 on the left side surface 72a, and a path length R3 that is the length of the left bottom surface 73a in the left-right direction. Since the left side surface 72a has the short circuit-preventing structure 75a, the path length R2 of the left side surface 72a is longer than the path length when no short circuit-preventing structure 75a is present and the left side surface 72a is flat, i.e., the vertical distance between the third layer 14c and the fifth layer 14e. Therefore, the path length R of the left connection surface 70a is longer than that when the short circuit-preventing structure 75a is not present.

In the present embodiment, the recesses 92 and the protrusions 93 are formed so as to extend in the direction of the center axis of the gas flow passage 13 (the front-back direction in this case), and the short circuit-preventing structures 75 are present on the inner circumferential surface of the casing 12 so as to extend in the direction of the center axis of the gas flow passage 13 from its inlet to its outlet. For example, as shown in an enlarged view on the left side of FIG. 1, the recesses 92 and the protrusions 93 included in the short circuit-preventing structure 75a are present on the inner circumferential surface of the casing 12 also near the gas inlet 13a (near the front end in this case). Therefore, the short circuit-preventing structures 75 are present on the inner circumferential surface of the casing 12 (the left and right side surfaces of the inner circumferential surface in this case) not only in the cross sections shown in FIGS. 3 and 4 but also in any cross section perpendicular to the center axis of the gas flow passage 13.

As shown in FIGS. 1 and 5, a plurality of terminals 19 are disposed on the upper and lower surfaces of the left end of the casing 12. The above-described electrodes 21, 22, 32, 34, 42, and 44 are electrically connected to their respective terminals 19 through wiring lines disposed in the casing 12. Similarly, the heater electrode 62 is electrically connected to two terminals 19 through wiring lines. For example, the wiring lines are disposed on the upper and lower surfaces of the first to eleventh layers 14a to 14k or disposed in through holes provided in the first to eleventh layers 14a to 14k. Although not illustrated in FIG. 2, the power sources 29, 39, 49, and 69 and the ammeter 52 are electrically connected to the respective electrodes in the particle detection element 11 through the terminals 19.

A method for producing the thus-configured particle detection element 11 will be described below. First, a plurality of unfired ceramic green sheets containing a ceramic raw material powder and corresponding to the first to eleventh layers 14a to 14k are prepared. Since the fourth, sixth, and eighth layers 14d, 14f, and 14h each include six layers 15a to 15f as described above, a total of 26 green sheets are prepared. Through holes and a space serving as the gas flow passage 13 are formed by, for example, punching in advance in each of the green sheets corresponding to the fourth to eighth layers 14d to 14h. Next, pattern printing processing for forming various patterns on the ceramic green sheets corresponding to the first to eleventh layers 14a to 14k and drying processing are performed. Specifically, the patterns to be formed are, for example, patterns for the electrodes, the wiring lines connected to the electrodes, the terminals 19, etc. The patterns are printed by applying a pattern forming paste to the green sheets using a known screen printing technique. During, before, and after the pattern printing processing, the through holes are filled with a conductive paste that later becomes wiring lines. Subsequently, printing processing for printing a bonding paste for laminating and bonding the green sheets and drying processing are performed. The green sheets with the bonding paste formed thereon are stacked in a prescribed order, and compression-bonding processing for forming one layered body is performed. Specifically, prescribed temperature-pressure conditions are applied to compression-bond the green sheets. When the compression-bonding processing is performed, a vanishing material (e.g., theobromine) that vanishes during firing is filled into the space that later becomes the gas flow passage 13 in advance. Then the layered body is cut to obtain a layered body having the size of the casing 12. Then the cut layered body is fired at a prescribed firing temperature. Since the vanishing material vanishes during firing, the portion filled with the vanishing material forms the gas flow passage 13. The particle detection element 11 is thereby obtained.

In each of the short circuit-preventing structures 75 in the present embodiment, the recesses 92 and the protrusions 93 correspond one-to-one with the layers 15a to 15f, and each of the plurality of step portions 94 is formed as a step between adjacent two of the layers 15a to 15f. Therefore, in the process of producing the particle detection element 11, when the green sheets that later become the layers 15a to 15f are subjected to punching treatment to form spaces that later become the gas flow passage 13, the spaces are formed such that adjacent green sheets to be stacked have respective spaces different in size (width in the left-right direction in this case). In this manner, by simply stacking the green sheets that later become the layers 15a to 15f, the short circuit-preventing structures 75 having the recesses 92 and the protrusions 93 are formed. Therefore, it is unnecessary to perform, for example, additional processing for forming shapes for the recesses 92 or the protrusions 93 after the punching processing performed on the green sheets or lamination of the plurality of green sheets.

The casing 12 formed of the ceramic material described above is preferable because the following effects are obtained. Generally, the ceramic material has high heat resistance and can easily withstand the temperature at which the particles 17 are removed using the heater electrode 62 as described later, e.g., a high temperature of 600° C. to 800° C. at which carbon, which is the main component of the particles 17, burns. Moreover, since the ceramic material generally has a high Young's modulus, the stiffness of the casing 12 can be easily maintained even when the walls and partitions of the casing 12 are thin, and therefore the deformation of the casing 12 caused by a thermal shock or an external force can be prevented. Since the deformation of the casing 12 is prevented, a reduction in the accuracy of detection of the number of particles due to, for example, a change in the electric field distribution in the gas flow passage 13 during discharge of the electric charge generator 20 or a change in the thicknesses (vertical heights) of the branched flow passages 13b to 13d can be prevented. Therefore, by forming the casing 12 using the ceramic material, the thicknesses of the walls and partitions of the casing 12 can be reduced to make the casing 12 more compact while the deformation of the casing 12 is prevented. No particular limitation is imposed on the ceramic material. Examples of the ceramic material include alumina, silicon nitride, mullite, cordierite, magnesia, and zirconia.

Next, an example of the use of the particle detector 10 will be described. When particles contained in exhaust gas from an automobile is measured, the particle detection element 11 is installed inside the exhaust pipe of the engine. In this case, the particle detection element 11 is installed such that the exhaust gas is introduced into the casing 12 from the gas inlet 13a, passes through the branched flow passages 13b to 13d, and is then discharged. The power sources 29, 39, 49, and 69 and the detector 50 are connected to the particle detection element 11.

The particles 17 contained in the exhaust gas introduced into the casing 12 from the gas inlet 13a are charged by the charges 18 (positive charges in this case) generated by discharge in the electric charge generator 20 and form charged particles P. In the excess electric charge removing unit 30, the electric field is weak, and the length of the removing electrode 34 is shorter than the length of the collecting electrodes 42. Therefore, the charged particles P pass through the excess electric charge removing unit 30 without any change, flow into any of the branched flow passages 13b to 13d, and reach the collector 40. The charges 18 not imparted to the particles 17 are attracted to the removing electrode 34 of the excess electric charge removing unit 30 even though the electric field is weak and are discarded to the GND through the removing electrode 34. Therefore, almost no unnecessary charges 18 not imparted to the particles 17 reach the collector 40.

The charged particles P that have reached the collector 40 are collected by any of the first to third collecting electrodes 42a to 42c through the electric field generated by the electric field generating electrodes 44. A current corresponding to the charges 18 on the charged particles P adhering to the collecting electrodes 42 is measured by the ammeter 52, and the arithmetic unit 54 computes the number of particles 17 based on the current. In the present embodiment, the first to third collecting electrodes 42a to 42c are connected to one ammeter 52, and the current corresponding to the total number of charges 18 on the charged particles P adhering to the first to third collecting electrodes 42a to 42c is measured by the ammeter 52. The relation between the current I and the amount of charges q is I=dq/(dt), q=∫Idt. The arithmetic unit 54 integrates (accumulates) the current value over a prescribed period to obtain the integrated value (accumulated charge amount), divides the accumulated charge amount by the elementary charge to determine the total number of charges (the number of collected charges), and divides the number of collected charges by the average number of charges (average charge number) imparted to one particle 17 to determine the number Nt of particles 17 adhering to the collecting electrodes 42. The arithmetic unit 54 detects the number Nt as the number of particles 17 in the exhaust gas. However, part of the particles 17 may pass through without being collected by the collecting electrodes 42 or may adhere to the inner circumferential surface of the casing 12 before collected by the collecting electrodes 42. Therefore, the collection ratio of particles 17 may be determined in advance in consideration of the ratio of particles 17 not collected by the collecting electrodes 42, and the arithmetic unit 54 may detect the total number Na, which is the value obtained by dividing the number Nt by the collection ratio, as the number of particles 17 in the exhaust gas.

When a large number of particles 17 etc. accumulate on the collecting electrodes 42, additional charged particles P may no longer be collected by the collecting electrodes 42. Therefore, by heating the collecting electrodes 42 by the heater electrode 62 periodically or at the time when the amount of accumulation reaches a prescribed amount, the accumulated materials on the collecting electrodes 42 are heated by the heater electrode 62 to incinerate the accumulated materials to thereby refresh the electrode surfaces of the collecting electrodes 42.

During the use of the particle detection element 11, part of the particles 17 (including the charged particles P) may gradually adhere to the inner circumferential surface of the casing 12 without being captured by the collecting electrodes 42. Generally, the particles 17 are often formed of conductive materials such as carbon. Therefore, when a large number of particles 17 adhere to the inner circumferential surface of the casing 12, the particles 17 may form a short circuit path along the inner circumferential surface of the casing 12, and the collecting electrodes 42 and the electric field generating electrodes 44 may be short-circuited. However, the casing 12 of the particle detection element 11 in the present embodiment has the short circuit-preventing structure 75a on the left connection surface 70a that is part of the inner circumferential surface exposed to the gas flow passage 13 and connects the first collecting electrode 42a to the first electric field generating electrode 44a. This short circuit-preventing structure 75a increases the path length R along the left connection surface 70a as described above. Therefore, even when particles 17 adhere to the left connection surface 70a, a short circuit path is unlikely to be formed on the left connection surface 70a. The presence of the short circuit-preventing structure 75a can prevent a short circuit between the first collecting electrode 42a and the first electric field generating electrode 44a. Similarly, since the right connection surface 80a has the short circuit-preventing structure 85a, a short circuit between the first collecting electrode 42a and the first electric field generating electrode 44a can be prevented. Similarly, since the left connection surface 70b and the right connection surface 80b have the short circuit-preventing structures 75b and 85b, respectively, a short circuit between the second collecting electrode 42b and the second electric field generating electrode 44b can be prevented. Since the left the connection surface 70c and the right connection surface 80c have the short circuit-preventing structures 75c and 85c, respectively, a short circuit between the third collecting electrode 42c and the third electric field generating electrode 44c can be prevented.

When particles 17 adhere to the inner circumferential surface of the casing 12, a short circuit path may be formed not only between the collecting electrodes 42 and the electric field generating electrodes 44 but also between electrodes exposed to the gas flow passage 13 and having difference potentials (between the application electrode 32 and the removing electrode 34 and between the discharge electrode 21 and the counter electrode 22). In the present embodiment, the recesses 92 and the protrusions 93 included in the short circuit-preventing structures 75 are formed so as to extend in the direction of the center axis of the gas flow passage 13, and the short circuit-preventing structures 75a to 75c and 85a to 85c are also present on the connection surface between the application electrode 32 and the removing electrode 34 and on the connection surface between the discharge electrode 21 and the counter electrode 22. Therefore, the presence of the short circuit-preventing structures 75 can prevent a short circuit between the application electrode 32 and the removing electrode 34 and a short circuit between the discharge electrode 21 and the counter electrode 22.

The correspondence between the components of the present embodiment and the components of the present invention will be explained. The casing 12 in the present embodiment corresponds to the casing in the present invention, and the electric charge generator 20 corresponds to the electric charge generating unit. The collecting electrodes 42 correspond to the collecting electrode, and the discharge electrode 21, the counter electrode 22, the application electrode 32, the removing electrode 34, the collecting electrodes 42, and the electric field generating electrodes 44 correspond to the exposed electrodes. The connection surfaces 70 correspond to the connection surface, and the short circuit-preventing structure 75 corresponds to the short circuit-preventing structure. The fifth and seventh layers 14e and 14g correspond to the partition, and the heater 60 corresponds to the heating unit. The upper surfaces of the fifth, seventh, and ninth layers 14e, 14g, and 14i correspond to the collecting electrode-disposed surface, and the lower surfaces of the third, fifth, and seventh layers 14c, 14e, and 14g correspond to the electric field generating electrode-disposed surface. The left side surfaces 72a to 72c and the right side surfaces 82a to 82c correspond to the connection side surface, and the detector 50 corresponds to the detection unit.

In the particle detection element 11 in the present embodiment described above in detail, the short circuit-preventing structures 75 including the recesses 92 and the protrusions 93 are disposed on the respective connection surfaces 70 that are part of the inner circumferential surface of the casing 12 that is exposed to the gas flow passage 13, the connection surfaces 70 connecting the exposed electrodes (the collecting electrodes 42 and the electric field generating electrodes 44). The short circuit-preventing structures 75 increase the path lengths R along the connection surfaces 70 between the collecting electrodes 42 and the electric field generating electrodes 44. Therefore, even when particles 17 adhere to the inner circumferential surface of the casing 12, a short circuit path is unlikely to be formed between each collecting electrode 42 and the corresponding electric field generating electrode 44. In this particle detection element 11, a short circuit between each collecting electrode 42 and the corresponding electric field generating electrode 44 can be prevented. Similarly, the connection surface between the discharge electrode 21 and the counter electrode 22, which are exposed electrodes, has the short circuit-preventing structures, and the connection surface between the application electrode 32 and the removing electrode 34, which are exposed electrodes, has the short circuit-preventing structures 75, so that a short circuit between these electrodes can also be prevented.

The casing 12 includes the fifth and seventh layers 14e and 14g that partition the gas flow passage 13 into the pluralities of branched flow passages 13b to 13d, and the first collecting electrode 42a and the first electric field generating electrode 44a are exposed to the branched flow passage 13b among the plurality of the branched flow passages 13b to 13d. When the first collecting electrode 42a and the first electric field generating electrode 44a are disposed so as to face the branched flow passage 13b, the vertical distance between the electrodes is small, so that the path length between these electrodes along each connection surface (each of the left connection surface 70a and the right connection surface 80a in this case) tends to be small. It is therefore highly significant to prevent a short circuit between these electrodes by disposing the short circuit-preventing structures 75a and 85a on the left connection surface 70a and the right connection surface 80a, respectively. This is also the case for a region between the second collecting electrode 42b and the second electric field generating electrode 44b and for a region between the third collecting electrode 42c and the third electric field generating electrode 44c. Specifically, one collecting electrode 42 and one electric field generating electrode 44 form a pair of electrodes, and the collector 40 includes a plurality of pairs (three pairs in this case) of electrodes such that one pair of electrodes is disposed in each of the plurality of the branched flow passage 13b to 13c. For each of the plurality of pairs of electrodes, its connection surface 70 has the corresponding short circuit-preventing structure 75. Therefore, for each of the pairs of electrodes disposed in the branched flow passages 13b to 13d, a short circuit between the collecting electrode 42 and the electric field generating electrode 44 can be prevented.

The casing 12 is a layered body including a plurality of layers (26 layers described above) stacked on top of each other. The recesses 92 and the protrusions 93 are connected to their surrounding portions at the step portions 94 on the connection surfaces 70, and each step portion 94 is a step between adjacent two of the plurality layers 15a to 15f (e.g., between the layers 15a and 15b). Therefore, the recesses 92 and the protrusions 93 can be formed by simply stacking the plurality of layers such that a step portion 94 is formed between each two adjacent layers. Specifically, in the present embodiment, layers having different shapes (e.g., the layer 15a and the layer 15b) are formed and stacked adjacent to each other to form a step portion 94, and the recesses 92 and the protrusions 93 are thereby formed. Therefore, the casing 12 having the recesses 92 and the protrusions 93 can be produced relatively more easily than when, for example, after the layer 14d is formed, the layer 14 is subjected to processing such as the formation of a recess 92 or a protrusion 93.

Moreover, the particle detection element 11 includes the heater 60 that heats the connection surfaces 70 of the casing 12. Therefore, by burning and removing the particles 17 on the connection surfaces 70 using the heater 60, the formation of a short circuit path on the connection surfaces 70 can be prevented. Since the connection surfaces 70 have the respective short circuit-preventing structures 75, a short circuit between the collecting electrodes 42 and the electric field generating electrodes 44 can be prevented. Therefore, the time interval during which the heater 60 is not used can be longer than that when no short circuit-preventing structures 75 are provided. The heater 60 can also prevent the formation of a short circuit path on the connection surface between the discharge electrode 21 and the counter electrode 22 and on the connection surface between the application electrode 32 and the removing electrode 34, and the time interval during which the heater 60 is not used can also be increased. In the present embodiment, the heater 60 serves also as a unit for burning particles on the collecting electrodes 42. Therefore, during a period of time during which the particles 17 on the connection surfaces 70 are burnt by the heater 60, the arithmetic unit 54 cannot detect the number of particles 17 (this period is referred to as dead time). However, in the particle detection element 11 in the present embodiment, the dead time can be shortened because the time interval during which the heater 60 is not used can be increased.

The present invention is not limited to the embodiment described above. It will be appreciated that the present invention can be embodied in various forms so long as they fall within the technical scope of the invention.

For example, in the above embodiment, the short circuit-preventing structure 75a has the recesses 92 and the protrusions 93, but this is not a limitation. It is only necessary that the short circuit-preventing structure 75a have only the recesses 92 or the protrusions 93, or both.

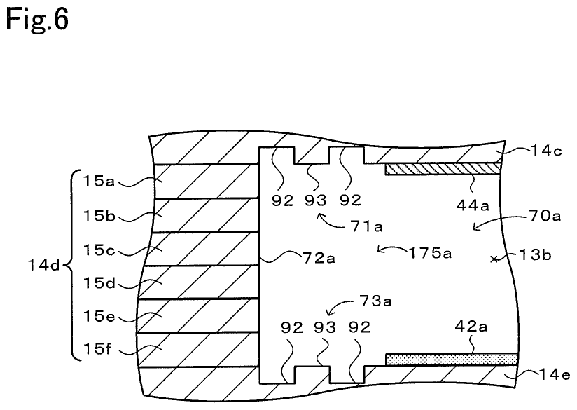

In the above embodiment, the left side surface 72a included in the left connection surface 70a has the short circuit-preventing structure 75a, but this is not a limitation. It is only necessary that the left connection surface 70a have the short circuit-preventing structure 75a. For example, as shown in FIG. 6, the left ceiling surface 71a and the left bottom surface 73a may each have a short circuit-preventing structure 175a. The fifth layer 14e having a protrusion 93 shown in FIG. 6 may be produced, for example, as follows. First, a layer having a shape with the protrusion 93 removed from the fifth layer 14e, i.e., a shape in which recesses 92 on both sides of the protrusion 93 are connected to form one recess, is formed by stacking a plurality of green sheets. Then a paste that later becomes the protrusion 93 is formed on the stacked green sheets by pattern printing.

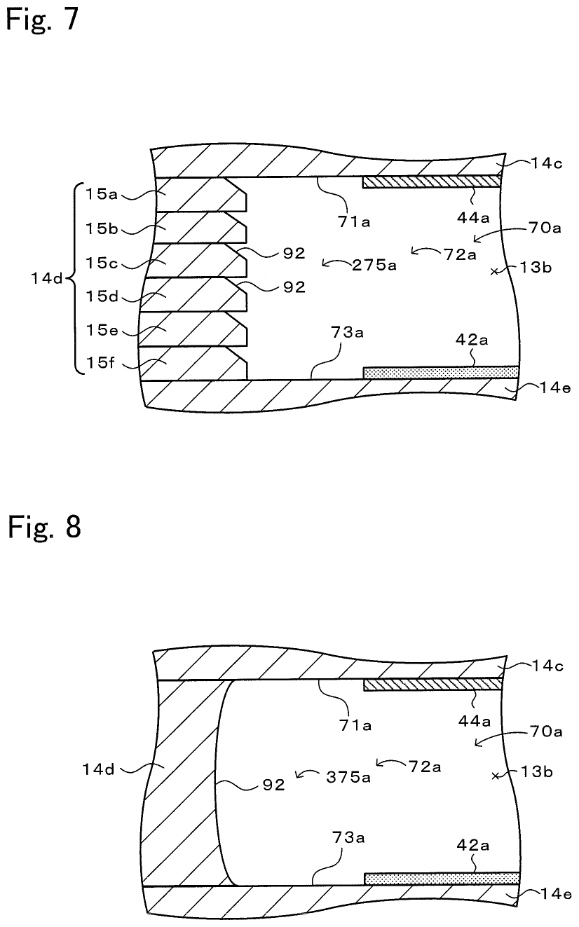

In the above embodiment, the end faces of the recesses 92 are parallel to the vertical direction, and a cross section of a space formed by each recess 92 is rectangular, but this is not a limitation. For example, as shown in a short circuit-preventing structure 275a in FIG. 7, the end face of each recess 92 may be an inclined surface. Alternatively, as shown in a short circuit-preventing structure 375a in FIG. 8, the end face of each recess 92 may be a curved surface. Similarly, the end face of each protrusion 93 may be an inclined surface or a curved surface.

In the above embodiment, the short circuit-preventing structure 75a has a shape formed from a plurality of layers 15a to 15f having different shapes, but this is not a limitation. For example, as shown in the short circuit-preventing structure 275a in FIG. 7, the short circuit-preventing structure 75a may be formed by stacking layers 15a to 15f having the same shape having at least one of a recess 92 and a protrusion 93.

In the above embodiment, the left connection surface 70a and the right connection surface 80a between the first collecting electrode 42a and the first electric field generating electrode 44a have the respective short circuit-preventing structures 75, but this is not a limitation. At least one of the left connection surface 70a and the right connection surface 80a may have the short circuit-preventing structure 75. For example, the short circuit-preventing structure 75 may be provided to at least one of the left and right connection surfaces 70a and 80a that has a shorter minimum path length determined on the assumption that no short circuit-preventing structure 75 is provided. This is also the case with the left connection surface 70b and the right connection surface 80b and with the left connection surface 70c and the right connection surface 80c.

In the above embodiment, the connection surfaces 70 for all the three pairs of electrodes (the first to third collecting electrodes 42a to 42c and the first to third electric field generating electrodes 44a to 44c) have the respective short circuit-preventing structures 75, but this is not a limitation. The connection surface 70 for one pair of electrodes may not have the short circuit-preventing structure 75. For example, the short circuit-preventing structure 75 may be provided to at least the connection surface 70 for one pair of the plurality of pairs of electrodes that has the shortest minimum path length determined on the assumption that no short circuit-preventing structure 75 is provided. Alternatively, no short circuit-preventing structure 75 may be provided to at least the connection surface 70 for one pair of the plurality of pairs of electrodes that has the longest minimum path length determined on the assumption that no short circuit-preventing structure 75 is provided. For example, the short circuit-preventing structure 75 may be provided to at least the connection surface 70 for one pair of the plurality of pairs of electrodes that has the smallest inter-electrode distance (e.g., the vertical distance between the first collecting electrode 42a and the first electric field generating electrode 44a). Alternatively, no short circuit-preventing structure 75 may be provided to at least the connection surface 70 for one pair of the plurality of pairs of electrodes that has the largest inter-electrode distance.

In the above embodiment, the connection surfaces between the discharge electrode 21 and the counter electrode 22, between the application electrode 32 and the removing electrode 34, and between the collecting electrodes 42 and the electric field generating electrodes 44 among the exposed electrodes have the respective short circuit-preventing structures 75, but this is not a limitation. When the connection surface connecting at least two of the plurality of exposed electrodes has the short circuit-preventing structure, a short circuit between the at least two electrodes can be prevented. The connection surface having the short circuit-preventing structure is not limited to the connection surface between exposed surfaces facing each other with the gas flow passage 13 interposed therebetween. For example, the connection surface connecting the application electrode 32 to the first electric field generating electrode 44a (part of the lower surface of the third layer 14c) may have the short circuit-preventing structure.

In the above embodiment, one pair of the collecting electrode 42 and the electric field generating electrode 44 is disposed in each of the branched flow passages 13b to 13d, but this is not a limitation. At least one pair may be disposed in each of the branched flow passages 13b to 13d. A branched flow passage with no pair of electrodes disposed therein may be present. In this case also, at least one collecting electrode 42 may be disposed in each of the plurality of the branched flow passages 13b to 13d. When at least one collecting electrodes 42 is disposed in each of the plurality of the branched flow passages 13b to 13d, the charged particles P are easily collected by the collecting electrodes 42.

In the above embodiment, the short circuit-preventing structures 75 are present on the inner circumferential surface of the casing 12 in any cross section perpendicular to the center axis of the gas flow passage 13, but this is not a limitation. For example, when the short circuit-preventing structure 75a is disposed on the left connection surface 70a, it is only necessary that the short circuit-preventing structure 75a be present in a given cross section perpendicular to the center axis of the gas flow passage 13. However, it is preferable that the short circuit-preventing structure 75a is present in any cross section of the left connection surface 70a that is perpendicular to the center axis of the gas flow passage 13, as in the above embodiment. The left connection surface 70a included in the inner circumferential surface of the casing 12 is a surface including at least a portion that forms the minimum left-side path between the first collecting electrode 42a and the first electric field generating electrode 44a on the assumption that no short circuit-preventing structure 75a is provided. For example, in the above embodiment, the first collecting electrode 42a and the first electric field generating electrode 44a face each other. In this case, assume that the short circuit-preventing structure 75a is not present. Then, in the inner circumferential surface of the casing 12 that is exposed to the gas flow passage 13, a left portion in any cross section perpendicular to the center axis of the gas flow passage 13 and passing through the first electric field generating electrode 44a and the first collecting electrode 42a is the minimum left-side path between the first collecting electrode 42a and the first electric field generating electrode 44a. Therefore, the left connection surface 70a is defined as a surface containing at least a set of these portions (left-side portions that are included in the inner circumferential surface of the casing 12 that is exposed to the gas flow passage 13 and appear in cross sections perpendicular to the center axis of the gas flow passage 13 and passing through the first electric field generating electrode 44a and the first collecting electrode 42a). This is also the case with other connection surfaces such as the connection surfaces 70 other than the left connection surface 70a.

In the above embodiment, the recesses 92 and the protrusions 93 correspond one-to-one with the layers 15a to 15f, but this is not a limitation. For example, one protrusion 93 may be formed as a layered body including a plurality of layers having the same shape and stacked vertically. In this case also, the effect obtained when each of the plurality of step portions 94 is formed as a step between adjacent two of the layers 15a to 15f can be obtained, as in the above embodiment. Specifically, this effect is that the recesses 92 and the protrusions 93 can be produced relatively more easily than when additional processing for providing the recesses 92 and the protrusions 93 is performed.

In the above embodiment, the green sheets that later become the layers 15a to 15f have spaces formed such that the sizes (the widths in the left-right direction in this case) of the spaces in adjacent stacked green sheets differ from each other, and the step portions 94 are thereby formed in the stacked green sheets, but this is not a limitation. For example, the sizes of the spaces formed in the green sheets that later become the layers 15a to 15f may be the same. In this case, the green sheets are stacked such that two adjacent layers are displaced from each other to form a step portion 94 therebetween. In this case also, the casing 12 having the recesses 92 and the protrusions 93 can be relatively easily produced, as in the above embodiment.

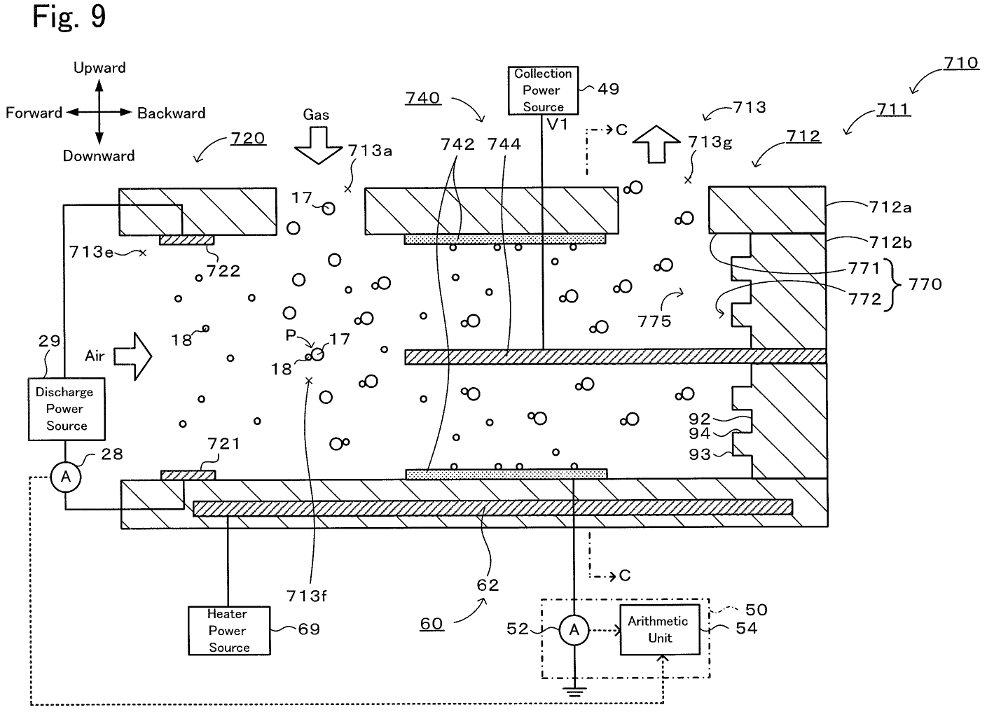

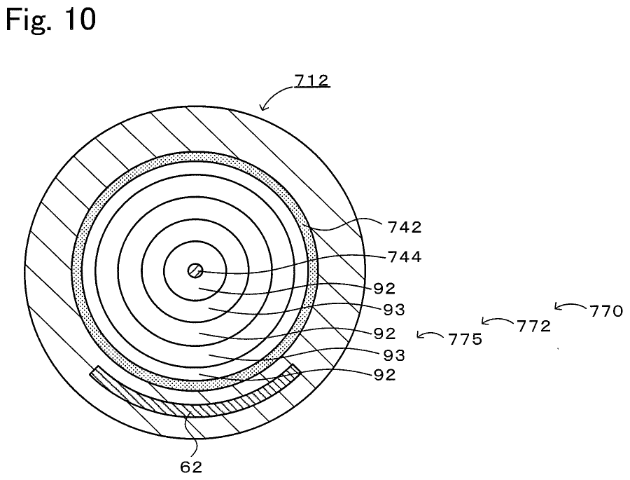

In the above embodiment, a cross section of the gas flow passage 13 that is perpendicular to the center axis has a substantially rectangular shape, but this is not a limitation. For example, the cross section of the gas flow passage 13 that is perpendicular to the center axis of the gas flow passage 13 may have a circular (perfect circular) shape (see FIGS. 9 and 10 described later), an elliptical shape, or a polygonal shape other than the rectangular shape.

In the above embodiment, the heater 60 includes the heater electrode 62 embedded between the tenth and eleventh layers 14j and 14k, but this is not a limitation. The heater 60 may be exposed to the gas flow passage 13. The heater 60 may have a plurality of heater electrodes, i.e., may further include a heater electrode embedded between the first and second layers 14a and 14b.

In the above embodiment, the gas flow passage 13 includes the branched flow passages 13b to 13d, but the number of branched flow passages may be two or four or more. The gas flow passage 13 may not be branched.

In the above embodiment, the electric field generating electrodes 44 are exposed to the gas flow passage 13, but this is not a limitation. The electric field generating electrodes 44 may be embedded in the casing 12. Instead of the first electric field generating electrode 44a, a pair of electric field generating electrodes may be provided in the casing 12 so as to vertically sandwich the first collecting electrode 42a therebetween, and the charged particles P may be moved toward the first collecting electrode 42a through an electric field generated by a voltage applied between the pair of electric field generating electrodes. This also applies to the second to third electric field generating electrodes 44b to 44c. The above also applies to the application electrode 32. Specifically, the application electrode 32 may be embedded in the casing 12. Instead of the application electrode 32, a pair of application electrodes sandwiching the removing electrode 34 vertically may be provided in the casing 12.

In the above embodiment, each of the collecting electrodes 42 faces a corresponding one of the electric field generating electrodes 44, but this is not a limitation. For example, the number of electric field generating electrodes 44 may be smaller than the number of collecting electrodes 42. For example, in FIG. 2, the second and third electric field generating electrodes 44b and 44c may be omitted, and the charged particles P may be moved toward the first to third collecting electrodes 42a to 42c through the electric field generated by the first electric field generating electrode 44a. In this case, the first electric field generating electrode 44a is considered as forming a pair of electrodes with the nearest first collecting electrode 42a, and at least the left connection surface 70a or the left connection surface 70b may have the short circuit-preventing structure 75. Each of the first to third electric field generating electrodes 44a to 44c causes the charged particles P to move downward, but this is not a limitation. For example, the first collecting electrode 42a and the first electric field generating electrode 44a in FIG. 2 may be arranged in reverse.

In the above embodiment, the first to third collecting electrodes 42a to 42c are connected to one ammeter 52, but this is not a limitation. The first to third collecting electrodes 42a to 42c may be connected to respective ammeters 52. In this manner, the arithmetic unit 54 can compute the numbers of particles 17 adhering to the first to third collecting electrodes 42a to 42c separately. In this case, for example, by applying different voltages to the first to third electric field generating electrodes 44a to 44c or using branched flow passages 13b to 13d having different passage thickness (the vertical heights in FIGS. 2 and 3), the first to third collecting electrodes 42a to 42c can collect particles 17 having respective different particle diameters.

In the above embodiment, the voltage V1 is applied to the first to third electric field generating electrodes 44a to 44c, but no voltage may be applied thereto. Even when the electric field generating electrodes 44 generate no electric field, if the passage thickness of the branched flow passages 13b to 13d is set to a very small value (e.g., 0.01 mm or more and less than 0.2 mm), charged particles P having a relatively small diameter under strong Brownian motion can be caused to collide with the collecting electrodes 42. The collecting electrodes 42 can thereby collect the charged particles P. In this case, the particle detection element 11 may not include the electric field generating electrodes 44.

In the above embodiment, the discharge electrode 21 and the counter electrode 22 are flat plate-shaped electrodes, but this is not a limitation. For example, the discharge electrode 21 may be a needle-shaped electrode. In this case, when a high voltage is applied between the needle-shaped discharge electrode 21 and the counter electrode 22, an aerial discharge (a corona discharge in this case) occurs due to the potential difference between the two electrodes. When the gas passes through the aerial discharge, charges 18 are imparted to the particles 17 in the gas to form charged particles P, as in the above embodiment. Alternatively, the electric charge generator 20 may include a discharge electrode and a ground electrode with a dielectric interposed therebetween. In this case, when a high-frequency voltage (for example, a pulse voltage) is applied between the discharge electrode and the ground electrode from the discharge power source 29, the electric charge generator 20 generates a dielectric barrier discharge to cause charges 18 to be generated from the discharge electrode. Therefore, the electric charge generator 20 in this case can also impart the charges 18 to the particles 17 in the gas, as in the above embodiment. The casing 12 may be used as the dielectric. For example, when the discharge electrode is exposed to the gas flow passage 13 and the ground electrode is embedded in the casing 12, a portion of the casing 12 that is located between the discharge electrode and the ground electrode serves as the dielectric.

In the above embodiment, the collecting electrodes 42 are disposed on the downstream side of the electric charge generator 20 with respect to the gas flow within the casing 12, and the gas containing the particles 17 is introduced into the casing 12 from the upstream side of the charge generating element 20. However, this structure is not a limitation. In the above embodiment, the collection target of the collecting electrodes 42 is the charged particles P, but the collection target may be charges 18 not imparted to the particles 17. For example, a particle detection element 711 in a modification shown in FIG. 9 and a structure of a particle detector 710 including the particle detection element 711 may be employed. FIG. 10 is a C-C cross-sectional view of FIG. 9. The particle detection element 711 does not include the excess electric charge removing unit 30 and includes a casing 712, an electric charge generator 720, a collector 740, and a gas flow passage 713 instead of the casing 12, the electric charge generator 20, the collector 40, and the gas flow passage 13. The casing 712 includes a substantially cylindrical main body 712a and a bottom portion 712b that is disposed so as to close the rear end opening of the main body 712a and serves also as a support member that supports an electric field generating electrode 744. The electric charge generator 720 includes a discharge electrode 721 and a counter electrode 722 disposed so as to face the discharge electrode 721. The discharge electrode 721 and the counter electrode 722 are disposed on the inner circumferential surface of the main body 712a, and the shapes of the discharge electrode 721 and the counter electrode 722 in a cross section perpendicular to the direction of the center axis of the gas flow passage 713 (the front-back direction in this case) are circularly arcuate. The counter electrode 722 is disposed on the upper side of the inner circumferential surface of the gas flow passage 713 of the casing 712. A high voltage is applied between the discharge electrode 721 and the counter electrode 722 from the discharge power source 29. The particle detector 710 includes an ammeter 28 that measures a current during the application of the voltage by the discharge power source 29. The collector 740 includes: a collecting electrode 742 disposed on the inner circumferential surface of the gas flow passage 713 of the main body 712a; and the electric field generating electrode 744 disposed near the center axis of the gas flow passage 713 (near the center axis of the main body 712a in this case). As shown in FIG. 10, the collecting electrode 742 has a circular shape (ring shape) in a cross section perpendicular to the direction of the center axis of the gas flow passage 713 (the front-back direction in this case). As shown in FIGS. 9 and 10, the collecting electrode 742 is a cylindrical electrode whose axial direction extends in the front-back direction. The detector 50 is connected to the collecting electrode 742, and the collecting power source 49 is connected to the electric field generating electrode 744. The potential of the counter electrode 722 may be the same as the potential of the collecting electrode 742. The discharge electrode 721, the counter electrode 722, the collecting electrode 742, and the electric field generating electrode 744 are exposed electrodes exposed to the gas flow passage 713. The gas flow passage 713 includes an air inlet 713e, a gas inlet 713a, a mixing region 713f, and a gas outlet 713g. The air inlet 713e has an opening portion extending in the axial direction of the main body 712a at the front end of the casing 712, and a gas not containing the particles 17 (air in this case) is introduced into the casing 712 through the electric charge generator 20. The gas inlet 713a is a through hole passing vertically through an upper portion of the main body 712a and introduces a gas containing the particles 17 into the casing 712 such that the gas does not pass through the electric charge generator 20. The mixing region 713f is disposed downstream of the electric charge generator 720 but upstream of the collector 740, and the air from the air inlet 713e and the gas from the gas inlet 713a are mixed in the mixing region 713f. The gas outlet 713g is a through hole passing vertically through an upper portion of the main body 712a and discharges the gas passing through the mixing region 713f and the collector 740 to the outside of the casing 712. In this particle detector 710, the size of the collecting electrode 742 and the intensity of the electric field on the collecting electrode 742 (i.e., the magnitude of the voltage V1) are set such that the charged particles P are discharged from the gas outlet 713g without being collected by the collecting electrode 742 and that charges 18 not imparted to the particles 17 are collected by the collecting electrode 742. In the particle detection element 711, the heater electrode 62 is embedded in a lower portion of the main body 712a. However, the heater electrode 62 may be embedded in another portion such as an upper portion of the main body 712a or a bottom portion 712b.

Part of the inner circumferential surface of the casing 712 is a connection surface 770 that connects the collecting electrode 742 to the electric field generating electrode 744. The connection surface 770 includes: a first surface 771 that is part of the inner circumferential surface of the main body 712a and is located rearward of the collecting electrode 742; and a second surface 772 that is a surface of the bottom portion 712b (the front surface in this case) and is part of the inner circumferential surface. The second surface 772 has a short circuit-preventing structure 775. As shown in FIGS. 9 and 10, the short circuit-preventing structure 775 includes a plurality of (three in this case) recesses 92 and a plurality of (two in this case) of protrusions 93. The plurality of recesses 92 and the plurality of the protrusions 93 are alternately arranged concentrically about the electric field generating electrode 744.

In the thus-configured particle detector 710, when the discharge power source 29 applies a voltage between the discharge electrode 721 and the counter electrode 722 such that the discharge electrode 721 side has a higher potential, an aerial discharge occurs in the vicinity of the discharge electrode 721. In this case, charges 18 are generated in air between the discharge electrode 721 and the counter electrode 722 and imparted to the particles 17 in the gas within the mixing region 713f. Therefore, although the gas containing the particles 17 does not pass through the electric charge generator 720, the electric charge generator 720 can convert the particles 17 to the charged particles P, as dose the electric charge generator 20. Since the gas containing the particles 17 does not pass through the electric charge generator 720, the particles 17 are unlikely to adhere to portions of the inner circumferential surface of the casing 712 that are close to the discharge electrode 721 and the counter electrode 722. Therefore, a short circuit path is unlikely to be formed between the discharge electrode 721 and the counter electrode 722 that are exposed electrodes. Moreover, the discharge electrode 721 and the counter electrode 722 are prevented from being soiled with the adhered particles 17.

In the particle detector 710, the voltage V1 applied by the collection power source 49 causes an electric field directed from the electric field generating electrode 744 toward the collecting electrode 742 to be generated, and the collecting electrode 742 thereby collects the collection target (the charges 18 not imparted to the particles 17 in this case). The charged particles P are not collected by the collecting electrode 742 and are discharged from the gas outlet 713g. The arithmetic unit 54 obtains, as an input, the current value based on the charges 18 collected by the collecting electrode 742 from the ammeter 52 and detects the number of particles 17 in the gas based on the input current value. For example, the arithmetic unit 54 determines the number of charges 18 (the number of transmitted charges) transmitted through the gas flow passage 713 without being collected by the collecting electrode 742 by deriving the current difference between a current value measured by the ammeter 28 and a current value measured by the ammeter 52 and dividing the derived current difference value by the elementary charge. Then the arithmetic unit 54 computes the number Nt of particles 17 in the gas by dividing the number of transmitted charges by the average number of charges 18 (the average charge number) imparted to one particle 17. Even when the collection target of the collecting electrode 742 is not the charged particles P but the charges 18 not imparted to the particles 17 as described above, the number of particles 17 in the gas can be detected using the particle detection element 711 because there is a correlation between the number of collection target objects collected by the collecting electrode 742 and the number of particles 17 in the gas. Since the collecting electrode 742 does not collect the charged particles P, the collecting electrode 742 is unlikely to be soiled.

During the use of the particle detector 710, part of the particles 17 (including the charged particles P) may gradually adhere to the inner circumferential surface of the casing 12. In this case, since the connection surface 770 between the collecting electrode 742 and the electric field generating electrode 744 (more specifically, the second surface 772) has the short circuit-preventing structure 775, the formation of a short circuit path due to the particles 17 adhering to the connection surface 770 is prevented. Therefore, a short circuit between the collecting electrode 742 and the electric field generating electrode 744 can be prevented, as in the above embodiment.

In the particle detection element 711, the collection ratio of charges 18 may be determined in advance in consideration of the ratio of the charges 18 not collected by the collecting electrode 742 among the charges 18 not imparted to the particles 17. In this case, the arithmetic unit 54 may derive the current difference by subtracting a value obtained by dividing the current value measured by the ammeter 52 by the collection ratio from the current value measured by the ammeter 28. The particle detector 710 may not include the ammeter 28. In this case, for example, the arithmetic unit 54 adjusts the voltage applied from the discharge power source 29 such that a prescribed number of charges 18 are generated per unit time. The arithmetic unit 54 derives the current difference between a prescribed current value (the current value corresponding to the prescribed number of charges 18 generated by the electric charge generator 720) and the current value measured by the ammeter 52.

In the above embodiment, the detector 50 detects the number of particles 17 in the gas, but this is not a limitation. The detector 50 may detect the particles 17 in the gas. For example, the detector 50 may not detect the number of particles 17 in the gas but may detect the amount of the particles 17 in the gas. Examples of the amount of the particles 17 include, in addition to the number of particles 17, the mass of the particles 17, and the surface area of the particles 17. When the detector 50 detects the mass of the particles 17 in the gas, the arithmetic unit 54 may determine the mass of the particles 17 in the gas, for example, by multiplying the number Nt of particles 17 by the mass (e.g., the average mass) of one particle 17. Alternatively, the relation between the amount of accumulated charges and the total mass of collected charged particles P may be stored as a map in the arithmetic unit 54 in advance, and the arithmetic unit 54 may directly derive the mass of the particles 17 in the gas from the amount of accumulated charges using the map. When the arithmetic unit 54 determines the surface area of the particles 17 in the gas, a method similar to the method for determining the mass of the particles 17 in the gas may be used. When the collection target of the collecting electrodes 42 is charges 18 not imparted to the particles 17, the detector 50 can detect the mass or surface area of the particles 17 using a similar method.

In the description of the above embodiment, the number of positively charged particles P is measured. However, the number of particles 17 can be measured in a similar manner when the charged particles P are negatively charged.

The present application claims priority from Japanese Patent Application No. 2017-171121 filed on Sep. 6, 2017, the entire contents of which are incorporated herein by reference.

What is claimed is:

1. A particle detection element used to detect particles in a gas, the particle detection element comprising:
a casing having a gas flow passage through which the gas passes;
an electric charge generating unit that imparts charges generated by a discharge to the particles in the gas introduced into the casing to thereby form charged particles;
a collecting electrode that is disposed inside the casing so as to be exposed to the gas flow passage and collects a collection target that is the charged particles or the charges not imparted to the particles; and
a plurality of exposed electrodes that include the collecting electrode and are exposed to the gas flow passage,
wherein the casing has a short circuit-preventing structure disposed on a connection surface that is part of an inner circumferential surface exposed to the gas flow passage, the connection surface connecting at least two of the plurality of exposed electrodes to each other, the short circuit-preventing structure including at least one of a recess and a protrusion.

2. The particle detection element according to claim 1,
wherein the exposed electrodes include an electric field generating electrode that is disposed inside the casing and generates an electric field that causes the collection target to move toward the collecting electrode,
wherein the casing has a partition that partitions the gas flow passage into a plurality of branched flow passages,
wherein the collecting electrode and the electric field generating electrode are each exposed to one of the plurality of branched flow passages, and
wherein the casing has the short circuit-preventing structure on the connection surface that is a portion connecting the collecting electrode and the electric field generating electrode to each other.

3. The particle detection element according to claim 2,
wherein the collecting electrode and the electric field generating electrode form a pair of electrodes, and the particle detection element comprises a plurality of the pairs of electrodes disposed such that each of the plurality of pairs of electrodes is disposed in a corresponding one of the plurality of branched flow passages, and
wherein the connection surface for at least one of the plurality of pairs of electrodes disposed in the respective branched flow passages has the short circuit-preventing structure.

4. The particle detection element according to claim 1,
wherein the casing is a layered body including a plurality of layers stacked on top of each other, and
wherein the at least one of the recess and the protrusion is connected to a surrounding portion thereof on the connection surface at a step portion that is a step between two adjacent layers of the plurality of layers.

5. The particle detection element according to claim 1, further comprising a heating unit that heats the connection surface of the casing.

6. The particle detection element according to claim 1,
wherein the exposed electrodes include an electric field generating electrode that is disposed inside the casing and generates an electric field that causes the collection target to move toward the collecting electrode,
wherein, in a cross section perpendicular to a center axis of the gas flow passage, the inner circumferential surface of the casing has a polygonal shape, wherein the inner circumferential surface includes; a collecting electrode-disposed surface which is a surface forming a side of the polygonal shape and on which the collecting electrode is disposed; and an electric field generating electrode-disposed surface which is a surface forming a side of the polygonal shape and on which the electric field generating electrode is disposed, and wherein the short circuit-preventing structure is disposed on a connection side surface that is part of the connection surface, which part connects the collecting electrode-disposed surface to the electric field generating electrode-disposed surface.

7. A particle detector comprising:
the particle detection element according to claim 1; and
a detection unit that detects the particles based on a physical quantity that varies according to the collection target collected by the collecting electrode.
